(19) United States
(12) Patent Application Publication
(10) Pub. No.: US 2022/0138708 A1
(43) Pub. Date: May 5, 2022

(54) DISPOSITION OF TRANSACTIONS AFTER-THE-FACT

(71) Applicant: Wells Fargo Bank, N.A., San Francisco, CA (US)

(72) Inventors: Wayne Barakat, Novato, CA (US); Vsevolod Goldyak, Daly City, CA (US); Kumaran Perumal, San Francisco, CA (US); Steven E. Puffer, Champlin, MN (US); Thuang Huoi T. Spain, Newport Beach, CA (US)

(21) Appl. No.: 15/950,906

(22) Filed: Apr. 11, 2018

(51) Int. Cl. G06Q 20/10; G06Q 20/22; G06Q 30/02

(52) U.S. Cl. CPC G06Q 20/10; G06Q 30/0207; G06Q 20/227

(57) ABSTRACT

Examples described herein relate to apparatuses and methods that include determining that an initial transaction based on a first account of a user is processed for the user associated with a user device, determining attribute changes to the first account or to a second account of the user after the initial transaction has been processed, determining that the attribute changes to the first account or to the second account cause the second account to be more preferable than the first account, and automatically modifying the initial transaction to be based on the second account.

### BACKGROUND

Traditional electronic payment platforms do not provide any virtual assistance to notify or automatically amend payment methods (e.g., switching from using a first account of a user to a second account of the user) after a transaction has occurred, responsive to changes to attributes of the accounts of the user or events that have occurred after the transaction is processed. For instance, changes to attributes include changes to rewards or changes to interest rates associated with the first account and/or the second account, such that the second account becomes the more attractive account to use for the previously processed transaction. Examples of events include additional transactions processed after the original transaction using the first account and/or the second account such that rewards for the second account can be increased if the original transaction is paid using the second account. In some situations, the user may not have knowledge of the changes to the attributes of the accounts or the events that occurred after the transaction is processed. In some situations, the user is aware of the changes or the events but may not have been able to link the transaction that has already been processed to those changes or events. In such situations, the user may not be able to take advantages of those changes or events, thus failing to maximize benefits provided by the accounts.

### SUMMARY

In one arrangement, a method includes a transaction amendment server determining that an initial transaction is processed for a user associated with a user device, wherein the initial transaction is based on a first account of the user. Attribute changes to a second account of the user can be determined after the initial transaction has been processed. The transaction amendment server further determines that the attribute changes cause the second account to be more preferable than the first account. The initial transaction is automatically modified to be based on the second account.

In one arrangement, a provider computing system of a provider institution includes a processing circuit having a processor and a memory, where the processing circuit is configured to determine that an initial transaction is processed for a user associated with a user device, to determine attribute changes to a second account of the user after the initial transaction has been processed, to determine that the attribute changes cause the second account to be more preferable than the first account, and to automatically modify the initial transaction to be based on the second account. The initial transaction is based on a first account of the user.

In one arrangement, a non-transitory computer-readable medium having processor-readable instructions stored thereon such that, when executed by a processor, the instructions cause the processor to determine attribute changes to a second account of the user after the initial transaction has been processed, to determine that the attribute changes cause the second account to be more preferable than the first account, and to automatically modify the initial transaction to be based on the second account. The initial transaction is based on a first account of the user.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of an example of a system for providing post-transaction amendment of an electronic payment method according to some arrangements.

FIG. 2A is a diagram of the user device of the system set forth in FIG. 1 according to some arrangements.

FIG. 2B is a diagram of a provider institution computing system according to some arrangements.

FIG. 2C is a diagram of the transaction amendment server of the system set forth in FIG. 1 according to some arrangements.

FIG. 3 is a flow diagram illustrating a method for providing post-transaction amendment of an electronic payment method according to some arrangements.

FIG. 4A is a diagram illustrating a user interface for displaying information related to post-transaction amendment of an electronic payment method according to some arrangements.

FIG. 4B is a diagram illustrating a user interface for displaying information related to post-transaction amendment of an electronic payment method according to some arrangements.

### DETAILED DESCRIPTION

Arrangements described herein relate to systems, apparatuses, and methods associated with a smart system configured to amend or at least recommend changes to a user's decision to pay an electronic transaction using a first account (e.g., a financial account or instrument). In some implementations, the smart system can determine changes to the characteristics or attributes (e.g., rewards, interest rates, and the like) of the first account and/or other accounts of the user. Each of the other accounts is referred to herein as a “second account.” Examples of changes to attributes include but are not limited to, changes to rewards and changes to interest rates. Due to such changes, a second account may become the more desirable account to use for the previously processed transaction. In some implementations, the smart system can determine events that occur after the transaction has been processed. Due to such events, a second account may become the more desirable account to use for the previously processed transaction. Examples of events include but are not limited to, additional transactions using the second account processed after the initial transaction such that rewards for the second account can be improved if the initial transaction is paid using the second account instead of the first account. In such situations, the smart system can notify and/or automatically amend the initial transaction to be paid by the second account to allow the user to take advantages of changes or events occurred after the initial transaction.

In general, arrangements of the smart system described herein relate to amending of a transaction based on changes or events occurred after-the-fact. Traditionally, the user monitors his or her own accounts and payment instruments. The user may not have sufficient analytical resources to accurately determine how changes to the user's account attributes or events associated with the user's accounts can affect a previously processed transaction. This is because to accurately determine how the changes or the events can affect a previously processed transaction, the user must be able to gather information from a variety of electronic sources (e.g., provider institutions that provide the accounts) to evaluate the information in a holistic manner. The user is also unable to receive real-time updates to its account attributes due to a lack of direct interfacing with systems that provide such updates. The smart system described herein can learn or otherwise determine the manner in which the changes or the events can affect the previously processed transaction to assist the user in maximizing benefits.

In addition, traditionally to retroactively change a payment method from one account to another account, the user has to initiate a merchant refund. The merchant is requested to reversed the transaction and accept another account instead. Alternatively, the user may request a chargeback through a provider institution that provisions the first account used in the initial transaction. Both conventional methods require merchant involvement and a long processing time.

In other words, the smart system as described herein can be a virtual counselor or an automatic transaction amendment system that is knowledgeable about a user's account attributes (especially changes thereof) and transactions, storing and analyzing such information in real time. The arrangements described herein improve computer-related technology (e.g., automatic processing of electronic transactions) by performing certain steps that cannot be done by conventional systems or human actors. Accurate and timely determination of advantages of using a second account instead of a first account for a previously processed transaction can be beneficial in maximizing a user's benefits. In some instances, each processed transaction may have a window during which the transaction can be amended. The smart system can determine a deadline for making such amendments and analyze the changes and events based on the deadline to assure that the initial transaction can be amended based on the second account. Such organization of electronic information is impossible to be performed by a user in real time, due to limited interface and processing capabilities.

In some arrangements, to achieve benefits over conventional systems having databases, table, and field definitions that are static, the databases described herein may be data-type agnostic and configured to store different information for different users, transaction types, etc. Furthermore, to achieve benefits over conventional databases and to solve technical problems including improving dimensional scalability (such that different aspects of transactions may be analyzed for different users on the same data storage infrastructure as the smart system learns relevant aspects through pattern mining), and faster amendment services by reducing computer processing times for analyzing desirability of financial account needs qualifications of users receiving such services, the data stored in multidimensional form may be aggregated and/or stored using the disclosed arrangements. For example, the desirability of the accounts of the user may be dynamically calculated after being stored, when the data is retrieved for analysis and/or transaction processing.

In an example arrangement, the smart system includes a particular and unique set of rules, which are set up to account for and learn from account activities and changes to account attributes, and to produce an accurate determination of desirability of using the second account that traditionally would have required human intervention. Additionally, another particular and unique set of rules define transaction amendment (using the second account for the initial transaction), which traditionally would have required an evaluation by a human being (e.g., by the user as described herein) and cannot be done automatically. Further, arrangements described herein solve the internet-centric problem of automating electronic or digital transactions in a convenient manner (e.g., via a mobile device of a user), in real time.

In addition, arrangements described herein solve the technical problem of determining the appearance and functionality of an electronic user interface providing real-time alerts. In some arrangements, alerts can be displayed with a single click.

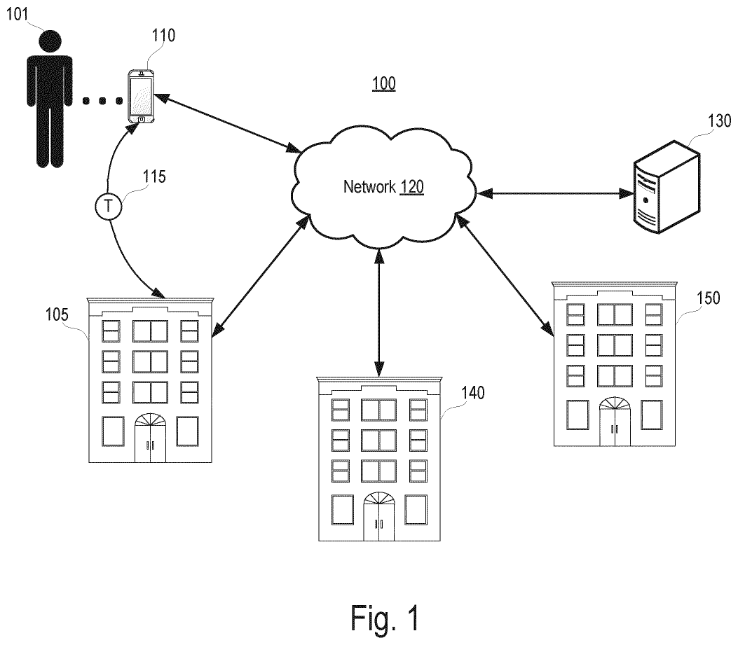

FIG. 1 is a diagram of an example of a system 100 for providing post-transaction amendment of an electronic payment method according to some arrangements. Referring to FIG. 1, a user 101 is a customer of at least one provider institution (e.g., a provider institution 140 and a provider institution 150). The user 101 can be any entity such as but is not limited to, an individual, a company, or the like. In some examples, each of the provider institutions 140 and 150 is a financial institution. The provider institutions 140 and 150 can store transaction information of customers, including the user 101. The provider institutions 140 and 150 can store the transaction information in respective transaction information databases. The provider institutions 140 and 150 can collect and store the transaction information in the course of dealing (e.g., processing transactions, offering products/services, and the like) with the customers. The provider institutions 140 and 150 can define, store, and alter account attributes (e.g., interest rates, rewards, and the like) for customers, including the user 101. While the provider institutions 140 and 150 are depicted as brick and mortar locations in FIG. 1, one of ordinary skill in the art can appreciate that one or more of the provider institutions 140 and 150 may not be associated with brick and mortar locations.

As used herein, “transaction information” of the user 101 includes information about financial activities of the user 101. In other words, the transaction information refers to information about transactions associated with the user 101, typically involving the user 101 obtaining goods and services from a merchant (e.g., a merchant 105) and providing funds to pay for the goods and the services. The funds can originate from accounts of the user 101. For example, each entry of the transaction information as stored in a corresponding database includes but is not limited to, an account type (e.g., saving, credit, checking, investment, retirement, mortgage, rewards, and the like), transaction amount, types of goods/services purchased, transaction time, associated user (e.g., the user 101), and the like. Given that the user 101 can hold accounts in more than one provider institution, the transaction information of the user 101 may be stored in two or more databases managed by two or more provider institutions (e.g., the provider institutions 140 and 150). While two provider institutions 140 and 150 are shown for illustrative purposes, one of ordinary skill in the art can appreciate that the entirety of the transaction information of the user 101 can be spread across and stored with one, or three or more provider institutions.

An initial transaction 115 is used to refer to a transaction paid with a first account of the user 101, before detecting the attribute changes or the events. The first account is provided and managed by the first provider institution 140. The transaction 115 is an electronic transaction between the user 101 and a merchant 105. Although the merchant 105 is represented using a brick and mortar location, one of ordinary skill in the art can appreciate that the transaction 115 is electronic in nature. That is, the transaction 115 may be facilitated by a user device 110 and a computing device (e.g., a server, a point-of-sale (POS) device, and the like) of the merchant 105.

The user 101 has a second account provided and managed by the second provider institution 150. While the second account is described to be provided by the second provider institution 150 for illustrative purposes, one of ordinary skill in the art can appreciate that the second account can merely be a different account provided by the first provider institution 140.

Each of the first account and the second account is defined by various attributes such as but not limited to, interest rate, rewards, credit limit, and the like. In some examples, reward attributes include a reward percentage, a reward amount, a threshold for attaining rewards, and the like. The provider institutions 140 and 150 may adjust the attributes associated with the first and second accounts for any suitable reason at any given time, without prior notice. While traditionally, the provider institutions 140 and 150 may send account notices to customers concerning such changes, the customers are not notified of the impact of such changes to previously made transactions (e.g., the initial transaction 115). Thus, in some arrangements, changes to the attributes to the first account and/or to the second account can make the second account more desirable in connection with the initial transaction 115. In addition, one or more transactions made subsequent to the initial transaction 115 can also make the second account more desirable in connection with the initial transaction 115.

The transaction amendment server 130 can receive information regarding the changes to the account attributes and/or the additional transactions subsequent to the initial transaction 115. Furthermore, the transaction amendment server 130 can receive information regarding the account attributes of the first account when the initial transaction 115 is made. Based on such information, the transaction amendment server 130 can determine whether the second account is more desirable than the first account to be used for the initial transaction 115. Responsive to determining that the second account is more preferable, the transaction amendment server 130 can notify the user 101 of such and/or automatically amend the initial transaction 115 to be based on the second account instead of the first account.

The user 101 operates the user device 110. The user device 110 is connected to the provider institutions 140 and 150 (e.g., connected to computing systems associated with the provider institutions 140 and 150) via a communication network 130 to access financial goods and services provided by the provider institutions 140 and 150. The user device 110 is connected to the merchant 105 (e.g., a computer device or a POS device associated thereof) via the communication network 130 to purchase goods or services provided by the merchant 105. Such purchase is commensurate with the initial transaction 115. Furthermore, the user device 110 and the provider institutions 140 and 150 (e.g., computer systems associated thereof) are connected to the transaction amendment server 130 via the communication network 130, such that the transaction amendment server 130 can receive the information regarding the account attributes of the first account when the initial transaction 115 is made, the account attribute information (e.g., changes to the account attributes), and subsequent transaction information.

The communication network 130 is any suitable Local Area Network (LAN) or Wide Area Network (WAN). For example, the communication network 130 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combinations thereof, and/or the like. The communication network 130 is structured to permit the exchange of data, values, instructions, messages, and the like among the user device 110, the provider institution 140, and the provider institution 150.

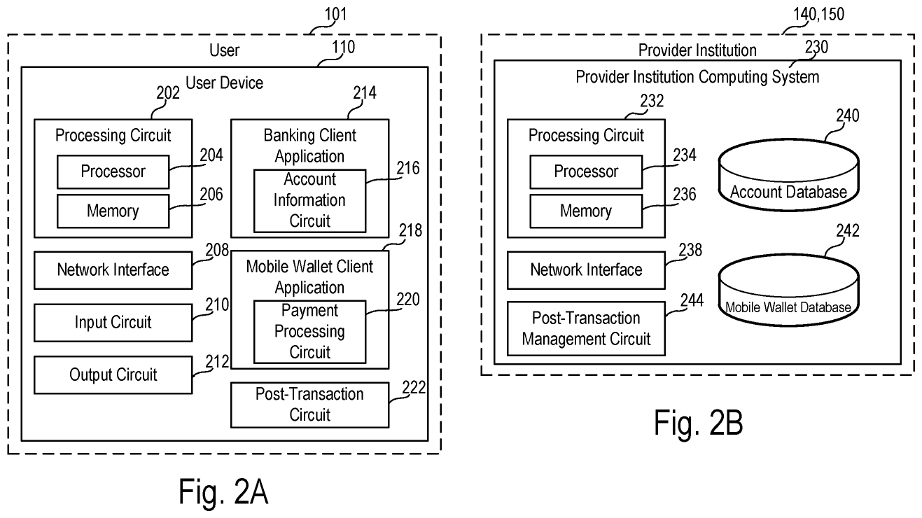

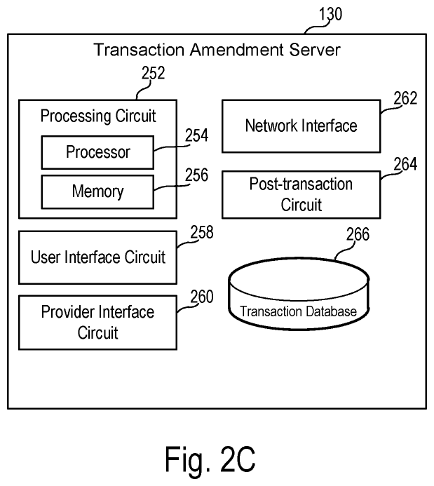

FIG. 2A is a diagram of the user device 110 of the system 100 set forth in FIG. 1 according to some arrangements. FIG. 2B is a diagram of a provider institution computing system 230 according to some arrangements. FIG. 2C is a diagram of the transaction amendment server 130 of the system 100 set forth in FIG. 1 according to some arrangements. Referring to FIGS. 1-2C, each of the provider institutions140 and 150 may include one or more of a bank branch, loan office, mortgage office, services office, retail office, automated teller machine (ATM) location, a combination thereof, and/or the like. Each of the provider institutions 140 and 150 has at least one associated provider institution computing system 230. In some examples, the provider institution computing system 230 is a financial institution computing system.

Each of the provider institutions 140 and 150 provides financial products and services such as but not limited to, credit card accounts, mobile wallet, checking/saving accounts, retirement accounts, mortgage accounts, loan accounts, investment and accounts, and the like to the user 101 via the provider institution computing system 230. As such, each of the first account and the second account may be an account such as but not limited to, a credit card account, a mobile wallet account, a checking/saving account, a retirement account, a mortgage account, a loan account, and an investment.

The provider institution computing system 230 includes a processing circuit 232 composed of a processor 234 and a memory device 236. The processor 234 can be implemented with a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 236 can be implemented with a Random Access Memory (RAM), Read-Only Memory (ROM), Non-volatile RAM (NVRAM), Flash Memory, hard disk storage, cloud storage, and other suitable electronic storage devices. The memory 236 stores data and/or computer code for facilitating at least some of the various processes described herein. The memory 236 includes tangible, non-transient volatile memory, or non-volatile memory. The memory 236 stores programming logic that, when executed by the processor 234, controls the operations of the provider institution computing system 230. In some arrangements, the processor 234 and the memory 236 form various processing circuits in the provider institution computing system 230.

As shown, the provider institution computing system 230 includes a network interface 238. The network interface 238 is structured for sending and receiving data over the communication network 130 (e.g., to and from the user device 110, another provider institution computing system, the transaction amendment server 130, and the like). Accordingly, the network interface 238 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like.

The provider institution computing system 230 includes an account database 240 that stores account information relating to one or more accounts held by the user 101 at an associated provider institution 140 or 150. The account information includes transaction information and account attributes. For example, the account database 240 stores transaction information relative to transactions made by the user 101 using one or more accounts of the user 101, for example, with a banking client application 214, a mobile wallet client application 218, or with other suitable applications. In another example, the account database 240 stores account attributes such as but not limited to, interest rate, rewards, credit limit, and the like. In some examples, reward attributes include a reward percentage, a reward amount, a threshold for attaining rewards, and the like.

The provider institution computing system 230 includes a mobile wallet account database 242 for storing mobile wallet accounts of customers, including the user 101. The mobile wallet accounts permit payments via the mobile wallet client application 218 of the user device 110. The mobile wallet account database 242 stores transaction information of transactions made by the user 101 using the mobile wallet client application 218. In other words, the mobile wallet account database 242 stores transaction information relative to transactions paid using the mobile wallet client application 218. As such, the account database 240 and the mobile wallet database 242 can be collectively referred to as the transaction information database of the provider institution computing system 230.

The provider institution computing system 230 includes a post-transaction management circuit 244 for managing post transaction amendments for customers (e.g., the user 101). In some examples, the post-transaction management circuit 244 can be implemented with the processing circuit 232. For example, the post-transaction management circuit 244 can be implemented as a software application stored within the memory 236 and executed by the processor 234. Accordingly, such examples can be implemented with minimal or no additional hardware costs. However, other implementations rely on dedicated hardware specifically configured for performing operations of the post-transaction management circuit 244. The post-transaction management circuit 244 can be operatively coupled to the account database 240 and the mobile wallet database 242 for retrieving transaction information concerning transactions made by the customer 101. The post-transaction management circuit 244 can also configure the network interface 238 to send changes to the account attributes associated with account(s) of the user 101 to the transaction amendment server 130 in real time, when the changes are defined by the provider institution 140 or 150. In that regard, the post-transaction management circuit 244 may include a suitable application programming interface (API) for communicating with the transaction amendment server 130 (e.g., a provider interface circuit 260).

As shown, the user 101 operates or is associated with the user device 110. In some arrangements, the user device 110 includes a processing circuit 202 having a processor 204 and memory 206. The processor 204 can be implemented with a general-purpose processor, an ASIC, one or more FPGAs, a DSP, a group of processing components that are distributed over various geographic locations or housed in a single location or device, or other suitable electronic processing components. The memory 206 can be implemented with RAM, NVRAM, ROM, Flash Memory, hard disk storage, and other suitable electronic storage components. The memory 206 stores data and/or computer code for facilitating the various processes described herein. Moreover, the memory 206 is or includes tangible, non-transient volatile memory or non-volatile memory. Accordingly, the memory 206 includes database components, object code components, script components, or any other type of information structure for supporting the various activities and information structures described herein.

The user device 110 is shown to include various circuits and logic for implementing the activities described herein. More particularly, the user device 110 includes one or more of the processing circuit 202, network interface 208, input circuit 210, output circuit 212, the banking client application 214, the mobile wallet client application 218, the post-transaction circuit 222, and the like. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included.

The network interface 208 is configured for and structured to establish a communication session via the communication network 130 with the provider institution computing system 230 and the transaction amendment server 130. Accordingly, the network interface 208 is an interface such as, but not limited to, the network interface 238.

The input circuit 210 is configured to receive user input the user 101. The output circuit 212 is configured to output information in the form of graphics, sound, tactile feedback (e.g., vibrations), and the like. In this regard, the input circuit 210 and the output circuit 212 are structured to exchange data, communications, instructions, etc. with an input/output component of the user device 110. Accordingly, in some arrangements, the input circuit 210 and the output circuit 212 can be combined into an input/output circuit that includes or is coupled to an input/output device such as but not limited to, a display device, touchscreen, keyboard, microphone, and/or the like. In some arrangements, the input/output circuit includes communication circuitry for facilitating the exchange of data, values, messages, and the like between the input/output device and the components of the user device 110. In some arrangements, the input circuit 210 and the output circuit 212 include machine-readable media for facilitating the exchange of information between the input/output device and the components of the user device 110. In still another arrangement, the input circuit 210 and the output circuit 212 include any combination of hardware components (e.g., a touchscreen), communication circuitry, and machine-readable media.

One or more of the banking client application 214 and mobile wallet client application 218 are server-based applications executable on the user device 110. In this regard, the user 101 first downloads the application(s) prior to usage. In another arrangement, the banking client application 214 and/or mobile wallet client application 218 are coded into the memory 206 of the user device 110. In still another arrangement, the banking client application 214 and/or mobile wallet client application 218 are web-based interface applications. In this configuration, the user 101 logs onto or otherwise accesses the web-based interface before usage. In this regard, at least one of the banking client application 214 and mobile wallet client application 218 is supported by a separate computing system comprising one or more servers, processors, network interface modules, etc. that transmit the applications for use to the user device 110. In certain arrangements, one or more of the banking client application 214 and/or mobile wallet client application 218 include an API and/or a Software Development Kit (SDK) that facilitate integration of other applications. All such variations and combinations are intended to fall within the spirit and scope of the present disclosure.

The banking client application 214 is communicably coupled to the provider institution computing system 230 (e.g., the account database 240) via the communication network 130 and is structured to permit management of at least one account of the user 101 via the banking client application 214. In this regard, the banking client application 214 provides displays indicative of account information such as, but not limited to, current account balances, pending transactions, profile information (e.g., contact information), reward associated with the account, bill pay information and/or the like. Further, in some arrangements, the banking client application 214 is configured to process payments from the user 101 to a designated recipient. For example, the banking client application 214 depicts a loan (e.g., mortgage) of the user 101 and allows the user 101 to pay the loan from an account (e.g., checking or savings). In some examples, a bill pay option is provided by the banking client application 214, where the bill pay option allows the user 101 to pay his/her bills in response to user input.

As mentioned herein, via the banking client application 214, the user 101 pays bills (e.g., mortgage), view balances, pays merchants, and otherwise manage accounts. Accordingly and as shown, the mobile bank client application 214 includes an account information circuit 216. The account information circuit 216 is linked or otherwise coupled to one or more accounts (as stored in the account database 240) held by the user 101 and permit management of the associated accounts (e.g., transfer balances between accounts, view payment history) by communicating with the provider institution computing system 230. The banking client application 214 is communicably coupled to the mobile wallet client application 218. As such, in response to a mobile payment via the mobile wallet client application 218, the mobile wallet client application 218 causes the banking client application 214 to update the payment account (i.e., the account that supported the mobile payment). As such, the applications 214 and 218 are communicably coupled to each other to enable actions supported by each respective application.

The mobile wallet client application 218 is communicably coupled to the provider institution computing system 230 (e.g., the mobile wallet database 242) via the communication network 130 and is structured to facilitate purchases by the user 101 via the mobile wallet client application 218. Accordingly, the mobile wallet client application 218 is linked or otherwise connected with one or more accounts (as stored in the account database 240) of the user 101. In operation, when at a POS terminal, the user 101 initiates the mobile wallet client application 218 and provides a passcode (e.g., biometrics such as a thumbprint, a Personal Identification Number (PIN), a password) to authenticate the user 101 and select the source payment account desired (e.g., a checking account from the provider institution 140 that is linked to the mobile wallet client application 218). Via communication with the payment terminal (e.g., via near field communication), the aforementioned payment information is provided to the POS terminal or the merchant (e.g., via NFC, via barcode presentment) and the payment is processed. Beneficially, carrying payment cards are avoided or reduced via the mobile wallet client application 218.

As mentioned herein, the mobile wallet client application 218 is structured to facilitate and permit payments by interfacing with an account held by the user 101 at the provider institution 140. Accordingly, the mobile wallet client application 218 is communicably coupled via the network interface 208 over the communication network 130 to the provider institution computing system 230. As shown, the mobile wallet client application 218 includes a payment processing circuit 220 structured to facilitate payments by the user 101 via the mobile wallet client application 218. For example, the payment processing circuit 216 enables a quick-pay capability with a merchant. In this regard, the payment processing circuit 216 includes or is communicably coupled with a communication device (e.g., a near-field communication chip) that facilitates the exchange of information between the mobile wallet client application 218 and a POS terminal.

While only one banking client application 214 and one mobile wallet client application 218 are shown, one of ordinary skill in the art can appreciate that the provider institutions 140 and 150 may require separate banking client applications and mobile wallet client applications. As such, the user device 110 may include a first banking client application for the provider institution computing system 230 of the first provider institution 140 and a second banking client application for the provider institution computing system 230 of the second provider institution 150. In addition, the user device 110 may include a first mobile wallet client application for the provider institution computing system 230 of the first provider institution 140 and a second mobile wallet client application for the provider institution computing system 230 of the second provider institution 150.

The user 101 can use the banking client application 214, the mobile wallet client application 218, or another suitable application on the user device 110 such as a browser application to process a transaction (e.g., the initial transaction 115).

In some arrangements, the post-transaction circuit 222 is operatively coupled to the transaction amendment server 130 (e.g., a user interface circuit 258). The post-transaction circuit 222 is configured to receive notifications from the transaction amendment server 130 (e.g., a user interface circuit 258) notifying the user 101 that using the second account is more desirable than using the first account. The post-transaction circuit 222 can configure the output circuit 212 to output the notification to the user 101. In some arrangements in which the transaction amendment server 130 automatically amends the initial transaction 115, the post-transaction circuit 222 is configured to receive notifications from the transaction amendment server 130 (e.g., a user interface circuit 258) notifying the user 101 that the initial transaction 115 is amended to be based on the second account instead of the first account. The post-transaction circuit 222 can configure the output circuit 212 to output such notification to the user 101.

In some arrangements, the transaction amendment server 130 includes a processing circuit 252 having a processor 254 and memory 256. The processor 254 can be implemented with a general-purpose processor, an ASIC, one or more FPGAs, a DSP, a group of processing components that are distributed over various geographic locations or housed in a single location or device, or other suitable electronic processing components. The memory 256 can be implemented with RAM, NVRAM, ROM, Flash Memory, hard disk storage, and other suitable electronic storage components. The memory 256 stores data and/or computer code for facilitating the various processes described herein. Moreover, the memory 256 is or includes tangible, non-transient volatile memory or non-volatile memory. Accordingly, the memory 256 includes database components, object code components, script components, or any other type of information structure for supporting the various activities and information structures described herein.

The transaction amendment server 130 is shown to include various circuits and logic for implementing the activities described herein. More particularly, the transaction amendment server 130 includes one or more of the processing circuit 252, network interface 208, input circuit 210, output circuit 212, the banking client application 214, the mobile wallet client application 218, the post-transaction circuit 222, and the like. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included. In some arrangements, the transaction amendment server 130 may be the provider institution computing system 230 of the provider institution 140 or 150.

The network interface 262 is configured for and structured to establish a communication session via the communication network 130 with the provider institution computing system 230 and the user device 110. Accordingly, the network interface 262 is an interface such as, but not limited to, the network interface 208 and 238.

In some arrangements, the user interface circuit 258 is operatively coupled to the user device 110 (e.g., the post-transaction circuit 222) via the communication network 130. The user interface circuit 258 can be implemented with the processing circuit 252. The user interface circuit 258 is configured to send notifications to the user device 110 to notify the user 101 that using the second account is more desirable than using the first account. In some arrangements in which the transaction amendment server 130 automatically amends the initial transaction 115, the user interface circuit 258 is configured to send notifications to the user device 110 notifying the user 101 that the initial transaction 115 is amended to be based on the second account instead of the first account. In that regard, the user interface circuit 258 includes suitable APIs for interfacing with the post-transaction circuit 222.

In some arrangements, the provider interface circuit 260 is operatively coupled to the provider institution computing system 230 (e.g., the post-transaction management circuit 244) via the communication network 130. The provider interface circuit 260 can be implemented with the processing circuit 252. The provider interface circuit 260 is configured to interface with the provider institution computing system 230 to receive the transaction information from the provider institution computing system 230. In that regard, the user interface circuit 258 includes suitable APIs for interfacing with the post-transaction management circuit 244.

In some arrangements, the post-transaction circuit 264 is configured to determine whether using an account separate from the first account is desirable for the initial transaction 115 in the manner described. The post-transaction circuit 264 is implemented with the processing circuit 252. The post-transaction circuit 264 is configured to determine whether the second account is more desirable to be used for the initial transaction as compared to the second account, based on the attribute changes and/or the additional transactions as described herein.

In some arrangements, the transaction database 266 can store information about transactions. The transaction information for various users, including the user 101, can be stored in the transaction database 266. Each transaction entry includes transaction information such as but not limited to, an account type (e.g., saving, credit, checking, investment, retirement, mortgage, rewards, and the like), transaction amount, types of goods/services purchased, transaction time, associated user (e.g., the user 101), and the like. In the scenario illustrated by FIG. 1, the transaction database 266 stores the transaction information associated with the initial transaction 115 and additional transactions made subsequent to the initial transaction 115.

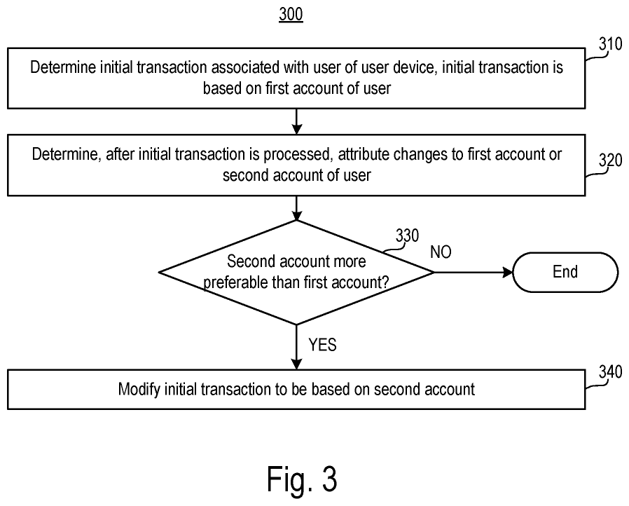

FIG. 3 is a flow diagram illustrating a method 300 for providing post-transaction amendment of an electronic payment method according to some arrangements. Referring to FIGS. 1-3, the user 101 may have to authorize the transaction amendment server 130 to automatically amend the initial transaction 115 by replacing the first account with another account (e.g., the second account). In that regard, the user 101 may authorize such amendment by providing corresponding user input via the input circuit 210. The user input can be relayed to the transaction amendment server 130.

At 310, the post-transaction circuit 264 determines that the initial transaction 115 is processed based on the first account of the user 101. In some arrangements, the transaction amendment server 130 can receive transaction information about transactions (e.g., the initial transaction 115) from the provider institution computing systems 230 of the provider institutions 140 and 150 in real time. In some arrangements, the transaction amendment server 130 can receive initial attributes of the first account from the provider institution computing systems 230 of the provider institutions 140. The initial attributes of the first account is applied to the initial transaction 115 based on the first account.

The merchant 105 is made whole when the initial transaction 115 is processed. Amendments to the initial transaction 115 in the manner described do not require a merchant refund or a chargeback. The transaction amendment server 130 communicates with the provider institution computing systems 230 of the provider institutions 140 and 150 to amend the initial transaction 115.

At 320, the post-transaction circuit 264 determines attribute changes to the first account or to a second account after the initial transaction 115 has been processed or otherwise cleared. The attribute changes to the second account are received from the provider computing system 230 associated with the provider institution 150 via the communication network 120 in real time. The attribute changes include changes to an interest rate, rewards, and credit limit with respect to the second account.

At 330, the post-transaction circuit 264 determines that the attribute changes to the first account or to the second account cause the second account to be more preferable than the first account. In general, financial health of the user 101 assuming that the second account is used for the initial transaction 115 is compared to financial health as the first account (e.g., the initial attributes of the first account). The second account is deemed to be more preferable than the first account responsive to determining that using the second account with the attribute changes to the second account yields more rewards than using the first account, the second account has a lower interest rate than an interest rate of the first account, and a reward threshold associated with second account can be met responsive to the initial transaction 115 being paid by the second account.

At 340, the post-transaction circuit 264 automatically modifies the initial transaction 115 to be based on the second account in response to determining that the attribute changes to the first account or to the second account cause the second account to be more preferable than the first account. For example, the post-transaction circuit 264 can communicate with the provider computing system 230 associated with the provider institution 140 to request to debit the first account a transaction amount of the initial transaction 115. The post-transaction circuit 264 can communicate with the provider computing system 230 associated with the provider institution 150 to request to credit the second account the transaction amount for the initial transaction 115.

In addition, the post-transaction circuit 264 determines that additional transactions using the second account may cause the second account to be more preferable than the first account. For example, the transaction circuit 264 determines that additional transactions (using the second account) processed after the initial transaction 115 is processed. The transaction circuit 264 determines that the additional transactions using the second account cause the second account to be more preferable than the first account. The additional transactions using the second account are determined to cause the second account to be more preferable than the first account responsive to determining that after processing the additional transactions using the second account, the second account yields more rewards than using the first account, the second account has a lower interest rate than an interest rate of the first account, or a reward threshold associated with second account can be met responsive to the initial transaction being paid by the second account. Likewise, the transaction circuit 264 automatically modifies the initial transaction to be based on the second account in response to determining that the additional transactions using the second account cause the second account to be more preferable than the first account.

In some arrangements, the post-transaction circuit 264 may configure the network interface 262 to send a notification to the provider computing system 230 associated with the provider institution 140, indicating that the first account is removed for the initial transaction 115. In some examples, the post-transaction circuit 264 may configure the network interface 262 to send the attribute changes to the second account to the provider computing system 230 associated with the provider institution 140. In that regard, the transaction amendment server 130 may receive a response from the provider computing system 230 associated with the provider institution 140 indicative of attribute changes to the first account. This allows the provider institution 140 an opportunity to beat the offer of the provider institution 150.

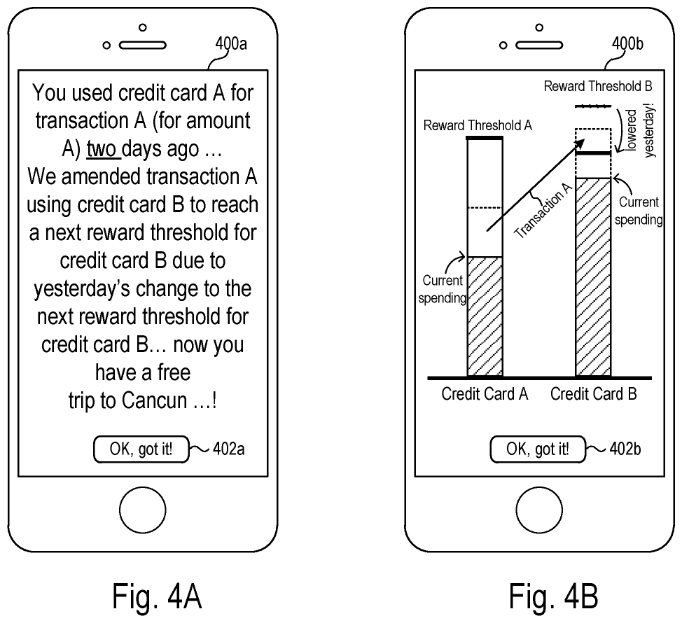

FIG. 4A is a diagram illustrating a user interface 400a for displaying information related to post-transaction amendment of an electronic payment method according to some arrangements. FIG. 4B is a diagram illustrating a user interface 400b for displaying information related to post-transaction amendment of an electronic payment method according to some arrangements. Referring to FIGS. 1-4B, the user interfaces 400a and 400b can be displayed by the output circuit 212 of the user device 110 to inform the user 101 of the automatic post-transaction amendment of an electronic payment (e.g., transaction A). Each of the user interfaces 400a and 400b may be an alert that can be displayed by the output circuit 212 automatically when the post-transaction amendment is made by the provider institution computing system 230. For example, responsive to amending the transaction in the manner described, the post-transaction management circuit 244 configures the network interface 238 to send a notification (along with a template/layout configuration associated therewith) to the user device 110. The user device 110 (e.g., the output circuit 212) can automatically force display the information contained in the notification without input of the user 101. For example, each of the user interfaces 400a and 400b can be displayed when a display device (e.g., a touchscreen) is in an off mode, by switching on the display device from an “off” or “sleep” mode to an “on” or “active” mode, or by switching the user device 110 as a whole from an “off” mode to an “on” mode. In other arrangements, each of the user interfaces 400a and 400b can be displayed with a single click or input by the user 101. In other words, the user 101 can select a user interactive element corresponding to displaying the user interface 400a or 400b.

The user interface 400a includes information about the original electronic payment method (e.g., the credit card A) based on which the transaction (e.g., transaction A for amount A) is processed. The user interface 400a also identifies a date (e.g., “two days ago”) of the processed transaction A. The user interface 400a further includes the new electronic payment method (e.g., the credit card B) based on which the transaction A was amended. The user interface 400a includes detected changes to the characteristics or attributes (e.g., rewards, interest rates, and the like) of the first account and/or other accounts of the user 101. For example, the user interface 400a indicates a lowered reward threshold B for credit card B since the original transaction A. The user interface 400a further includes a user interactive element 402a such that, responsive to being selected, closes the user interface 400a. In other arrangements, the user interface 400a includes user interactive elements for approving or denying a proposed amendment, as supposed to an automatically executed amendment. All such information can be appropriately positioned and sized to fit on a same screen of the user interface 400a, to avoid the need of the user 101 to scroll to view additional relevant information.

The user interfaces 400a and 400b may be alternative to one another, or the user interfaces 400a and 400b may be displayed in any suitable sequential order. The user interface 400b includes graphical depiction of the original electronic payment method (e.g., the credit card A) based on which the transaction (e.g., transaction A) is processed. The user interface 400a further includes the new electronic payment method (e.g., the credit card B) based on which the transaction A was amended. The user interface 400a includes graphical depiction of a relevant attribute of the two payment methods (e.g., credit cards A and B) and detected changes to the relevant attribute that enabled the amendment. For example, the user interface 400b displays, for example, in bar graphs, a reward threshold (e.g., reward threshold A and B) and a current spending for each payment method (e.g., credit card A and B, respectively). The user interface 400b further indicates a lowered reward threshold B for credit card B since the original transaction A. The user interface 400b graphically shows amending transaction A to be based on credit card B allows the user 101 to reach the lowered reward threshold B. The user interface 400b further includes a user interactive element 402b such that, responsive to being selected, closes the user interface 400b. In other arrangements, the user interface 400b includes user interactive elements for approving or denying a proposed amendment, as supposed to an automatically executed amendment. All such information can be appropriately positioned and sized to fit on a same screen of the user interface 400b, to avoid the need of the user 101 to scroll to view additional relevant information.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the arrangements might include a general purpose computing device in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method, comprising:
determining, by a transaction amendment server, that an initial transaction is processed for a user associated with a user device, the initial transaction is based on a first account of the user, and the initial transaction is processed based on interaction between the user device and a point-of-sale (POS) terminal;
receiving, by the transaction amendment server from one or more computing systems, reward changes to the first account or to a second account of the user after the initial transaction has been processed;
in response to receiving the reward changes, determining, by the transaction amendment server, a reward threshold associated with the second account is met responsive to the initial transaction being paid by the second account;
analyzing in real time, by the transaction amendment server, a window of time the second account can be selected for the initial transaction;
in response to determining the reward threshold associated with the second account is met, selecting, by the transaction amendment server, the second account for the initial transaction based on the reward changes to the first account or to the second account within the window of time and a predisposition of using the second account by the user, the predisposition of using the second account being determined through machine learning by analyzing previous transactions by the user to use the second account based on changes to the attributes to the second account;
automatically updating, by the transaction amendment server, the predisposition of using the second account based on the transaction amendment server selecting the second account for the initial transaction;
automatically modifying, by the transaction amendment server, the initial transaction to be based on the second account in response to selecting the second account;
sending, by the transaction amendment server, a real time notification to a provider of the first account indicative of the attributes of the second account and that the initial transaction is to be removed from the provider of the first account
receiving, by the transaction amendment server, a response from the provider indicative of attribute changes to the first account, the attribute changes to the first account exceeding the rewards threshold; and
selecting, by the transaction amendment server, the first account for the initial transaction based on the attribute changes to the first account.

2. The method of claim 1, further comprising receiving initial attributes of the first account, wherein
the initial attributes of the first account is applied to the initial transaction based on the first account; and
the second account being selected based on the initial attributes of the first account.

3. The method of claim 1, wherein
the one or more computing systems comprises a provider computing system associated with the second account; and
the reward changes to the second account are received from the provider computing system via the communication network in real time.

4. The method of claim 1, wherein the reward changes comprise changes to an interest rate, rewards, and credit limit.

5. The method of claim 1, wherein modifying the initial transaction to be based on the second account comprises:
debiting the first account a transaction amount of the initial transaction; and
crediting the second account the transaction amount for the initial transaction.

6. The method of claim 1, wherein the second account is selected responsive to determining that:
using the second account with the reward changes to the second account yields more reward points than using the first account; or
the second account has a lower interest rate than an interest rate of the first account.

7. The method of claim 1, further comprising:
determining, by the transaction amendment server, additional transactions using the second account after the initial transaction is processed based on the first account; and
automatically modifying, by the transaction amendment server, the initial transaction to be based on the second account in response to determining the additional transactions.

8. The method of claim 7, wherein the initial transaction is modified to be based on the second account responsive to determining that after processing the additional transactions using the second account:
the second account yields more reward points than using the first account; or
the second account has a lower interest rate than an interest rate of the first account.

9. The method of claim 1, further comprising sending a second notification to a first provider institution managing the first account for the user indicating that the first account is removed for the initial transaction.

10. The method of claim 1, further comprising:
sending the reward changes to the second account to a first provider computing system associated with the first account; and
receiving a response from the first provider computing system indicative of reward changes to the first account.

11. A transaction amendment server, comprising: a processing circuit having a processor and a memory, wherein the processing circuit is configured to:
determine that an initial transaction is processed for a user associated with a user device, the initial transaction is based on a first account of the user, and the initial transaction is processed based on interaction between the user device and a point-of-sale (POS) terminal;
receive, from one or more computing systems, reward changes to the first account or a second account of the user after the initial transaction has been processed;
in response to receiving the reward changes, determine a reward threshold associated with the second account is met responsive to the initial transaction being paid by the second account;
analyze in real time a window of time the second account can be selected for the initial transaction;
in response to determining the reward threshold associated with the second account is met, select the second account for the initial transaction based on the reward changes to the first account or to the second account within the window of time and a predisposition of using the second account by the user, the predisposition of using the second account being determined through machine learning by analyzing on previous transactions by the user to use the second account based on changes to the attributes to the second account;
automatically update the predisposition of using the second account based on the transaction amendment server selecting the second account for the initial transaction;
automatically modify the initial transaction to be based on the second account in response to selecting the second account;
send a real time notification to a provider of the first account indicative of the attributes of the second account and that the initial transaction is to be removed from the provider of the first account;
receive a response from the provider indicative of attribute changes to the first account, the attribute changes to the first account exceeding the rewards threshold; and
select the first account for the initial transaction based on the attribute changes to the first account.

12. The transaction amendment server of claim 11, wherein the processing circuit is further configured to receive initial attributes of the first account, wherein
the initial attributes of the first account is applied to the initial transaction based on the first account; and
the second account being selected based on the initial attributes of the first account.

13. The transaction amendment server of claim 11, wherein:
the one or more computing systems comprises a first provider computing system associated with the first account and a second provider computing system associated with the second account;
the reward changes to the first account are received from the first provider computing system via a communication network in real time; and
the reward changes to the second account are received from the second provider computing system via the communication network in real time.

14. The transaction amendment server of claim 11, wherein the reward changes comprise changes to an interest rate, rewards, and credit limit.

15. The transaction amendment server of claim 11, wherein the processing circuit modifies the initial transaction to be based on the second account by:
debiting the first account a transaction amount of the initial transaction; and
crediting the second account the transaction amount for the initial transaction.

16. The transaction amendment server of claim 11, wherein the processing circuit selects the second account responsive to determining that:
using the second account with the reward changes to the second account yields more reward points than using the first account; or
the second account has a lower interest rate than an interest rate of the first account.

17. The transaction amendment server of claim 11, wherein the processing circuit is further configured to:
determine additional transactions using the second account after the initial transaction is processed based on the first account; and
automatically modify the initial transaction to be based on the second account in response to determining the additional transactions.

18. The transaction amendment server of claim 17, wherein the processing circuit modifies the initial transaction to be based on the second account responsive to determining that after processing the additional transactions using the second account:
the second account yields more reward points than using the first account; or
the second account has a lower interest rate than an interest rate of the first account.

19. A non-transitory computer-readable medium having processor-readable instructions stored thereon such that, when executed by a processor, the instructions cause the processor to:
determine that an initial transaction is processed for a user associated with a user device, the initial transaction is based on a first account of the user, and the initial transaction is processed based on interaction between the user device and a point-of-sale (POS) terminal;
receive, from one or more computing systems, reward changes to the first account or a second account of the user after the initial transaction has been processed;
in response to receiving the reward changes, determine a reward threshold associated with the second account is met responsive to the initial transaction being paid by the second account;
analyze in real time a window of time the second account can be selected for the initial transaction;
in response to determining the reward threshold associated with the second account is met, select the second account for the initial transaction based on the reward changes to the first account or to the second account within the window of time and a predisposition of using the second account by the user, the predisposition of using the second account being determined through machine learning by analyzing previous transactions by the user to use the second account based on changes to the attributes to the second account;
automatically update the predisposition of using the second account based on the transaction amendment server selecting the second account for the initial transaction;
automatically modify the initial transaction to be based on the second account in response to selecting the second account;
send a real time notification to a provider of the first account indicative of the attributes of the second account and that the initial transaction is to be removed from the provider of the first account;
receive a response from the provider indicative of attribute changes to the first account, the attribute changes to the first account exceeding the rewards threshold; and
select the first account for the initial transaction based on the attribute changes to the first account.
